(19) United States
(12) Patent Application Publication
(10) Pub. No.: US 2020/0098500 A1
(43) Pub. Date: Mar. 26, 2020

(54) POINT-SYMMETRIC ON-CHIP INDUCTOR

(71) Applicant: Atmosic Technologies Inc., Campbell, CA (US)

(72) Inventor: Manolis TERROVITIS, Athens (GR)

(21) Appl. No.: 16/384,633

(22) Filed: Apr. 15, 2019

Related U.S. Application Data
(60) Provisional application No. 62/733,864, filed on Sep. 20, 2018.

(51) Int. Cl. H01F 17/00

(52) U.S. Cl. CPC H01F 17/0013; H01F 2017/0053; H01F 2017/0073

(57) ABSTRACT

A twin-spiral inductor is disclosed. The twin-spiral inductor may include a first spiral inductor configured to loop in a first direction, a second spiral inductor configured to loop in a second direction, opposite to the first direction, and a crossover conductor configured to connect the first spiral inductor to the second spiral inductor. The twin-spiral inductor may also include a first terminal disposed on an end of an inner loop of the first spiral inductor proximal to the crossover conductor and a second terminal disposed on an end of an inner loop of the second spiral inductor proximal to the crossover conductor, wherein each portion of the first spiral inductor has a corresponding portion in the second spiral inductor an identical distance and in an opposite direction from a central point.

### CROSS-REFERENCE TO RELATED APPLICATION

This application claims the benefit of co-pending and commonly owned U.S. Provisional Patent Application No. 62/733,864 entitled “POINT-SYMMETRIC ON-CHIP INDUCTOR” filed on Sep. 20, 2018, the entirety of which is hereby incorporated by reference.

### TECHNICAL FIELD

The present embodiments relate generally inductors, and specifically to point-symmetric on-chip inductors.

### BACKGROUND OF RELATED ART

Inductors may be used in many types of circuits including, for example, radio-frequency (RF) circuits, voltage-controlled oscillators (VCOs), low-noise amplifiers (LNAs), and passive-element filters. In general, an inductor is a passive electrical component that stores energy in a magnetic field. The inductor may produce a magnetic field when electric current flows through the conductor or produce an electric current in the conductor in response to a changing magnetic field.

An inductor may be formed using one or more turns of an electrical conductor, such as a metal (aluminum, copper, and the like) or a heavily doped semiconductor material. A planar inductor may be formed on any feasible plane surface including, but not limited to, integrated circuits and printed circuit boards. Some RF circuits use differential signal processing techniques to achieve enhanced linearity, dynamic range, and output power. Using non-symmetric electrical components, such as a non-symmetric inductor, in differential circuits may reduce circuit performance

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described herein may be implemented as an apparatus that may include a first spiral inductor configured to loop in a first direction, a second spiral inductor configured to loop in a second direction, opposite to the first direction, and a crossover conductor configured to connect the first spiral inductor to the second spiral inductor. In some implementations, the first spiral inductor and the second spiral inductor may form a twin-spiral inductor. The apparatus may also include a first terminal disposed on an end of an inner loop of the first spiral inductor proximal to the crossover conductor and a second terminal disposed on an end of an inner loop of the second spiral inductor proximal to the crossover conductor, wherein each portion of the first spiral inductor has a corresponding portion in the second spiral inductor that is an identical distance, in an opposite direction, from a central point of the twin-spiral inductor.

Another aspect of the subject matter of this disclosure may be implemented as a circuit. The circuit may include a first spiral inductor configured to loop in a first direction, a second spiral inductor configured to loop in a second direction, opposite to the first direction, and a crossover conductor configured to connect the first spiral inductor to the second spiral inductor. In some implementations, the first spiral inductor and the second spiral inductor may form a twin-spiral inductor. The circuit may also include a first terminal disposed on an end of an inner loop of the first spiral inductor proximal to the crossover conductor and a second terminal disposed on an end of an inner loop of the second spiral inductor proximal to the crossover conductor, wherein each portion of the first spiral inductor has a corresponding portion in the second spiral inductor that is an identical distance, in an opposite direction, from a central point of the circuit. The circuit may also include a drain terminal coupled to the first terminal of the first spiral inductor; and a second transistor comprising a drain terminal coupled to the second terminal of the second spiral inductor, wherein the first transistor and the second transistor are disposed on a second side of the substrate within a crossover area of the twin-spiral inductor.

### BRIEF DESCRIPTION OF THE DRAWINGS

Aspects of the present disclosure are illustrated by way of example and are not intended to be limited by the figures of the accompanying drawings. Like numbers reference like elements throughout the drawings and specification.

FIG. 1 shows a prior art example layout of a pair of step-symmetric spiral inductors.

FIG. 2 shows a prior art example layout of a twin-spiral inductor.

FIG. 3 is a top view of an example layout of a differential circuit in accordance with some embodiments.

FIG. 4 is a top view of another example layout of a differential circuit.

FIG. 5 is a top view of still another example layout of a differential circuit.

FIG. 6 is a top view of an example layout of electronic devices that may be located beneath a crossover area.

FIG. 7 is a top view of another example layout of electronic devices that may be located beneath a crossover area.

FIG. 8 is an example schematic of a radio-frequency amplifier circuit that may include the twin-spiral inductor of FIG. 5.

FIG. 9 is an example schematic of a voltage-controlled oscillator circuit that may include the twin-spiral inductor of FIG. 5.

### DETAILED DESCRIPTION

In the following description, numerous specific details are set forth such as examples of specific components, circuits, and processes to provide a thorough understanding of the disclosure. The term “coupled” as used herein means coupled directly to or coupled through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scope all embodiments defined by the appended claims.

The techniques described herein may be implemented in hardware, software, firmware, or any combination thereof, unless specifically described as being implemented in a specific manner Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described below. The non-transitory computer-readable storage medium may form part of a computer program product, which may include packaging materials.

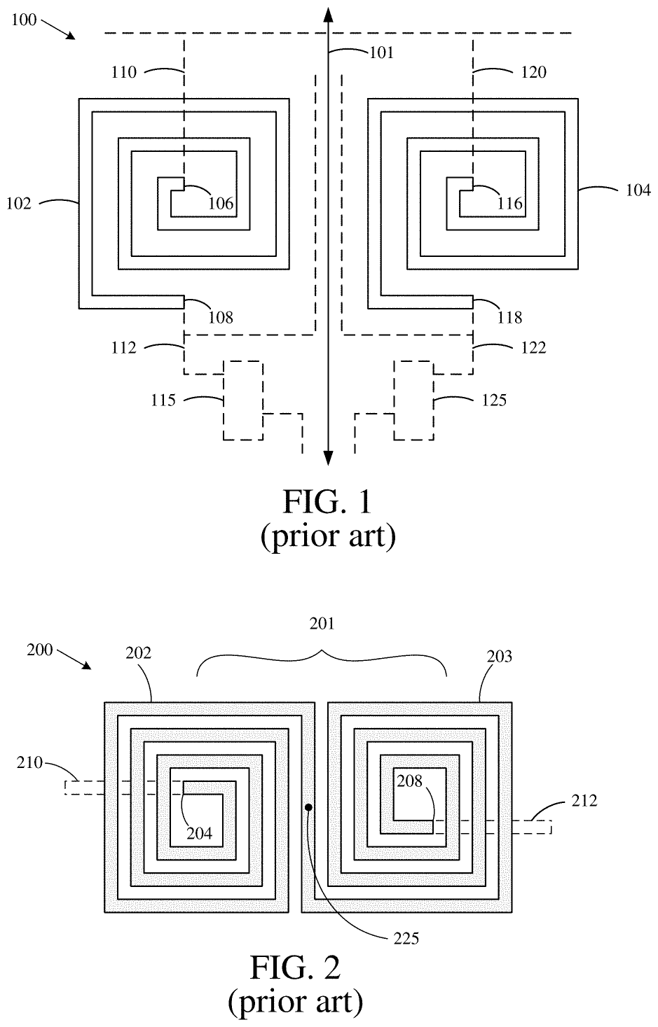

FIG. 1 shows a prior art example layout 100 of a pair of step-symmetric spiral inductors. Example step-symmetric spiral inductors are disclosed in U.S. Pat. No. 7,242,274, the entirety of which is hereby incorporated by reference. The layout 100 includes a first spiral inductor 102 and a second spiral inductor 104 disposed on a first layer of a substrate. The first spiral inductor 102 and the second spiral inductor 104 may be formed in a square pattern. The square pattern may provide more inductance for a given surface area and may be easily fabricated using standard integrated circuit techniques (e.g., as compared with inductors having a circular pattern).

The first spiral inductor 102 may include an inner terminal 106 and an outer terminal 108. Interconnect lines 110 and 112 may be connected to the inner terminal 106 and the outer terminal 108, respectively, to enable current to flow through first spiral inductor 102. Current flow through the first spiral inductor 102 may be controlled by a first transistor 115. Similarly, the second spiral inductor 104 may include an inner terminal 116 and an outer terminal 118. Interconnect lines 120 and 122 may be connected to the inner terminal 116 and the outer terminal 118, respectively, to enable current to flow through second spiral inductor 104. Current flow through the second spiral inductor 104 may be controlled by a second transistor 125. The dashed lines may indicate that the interconnect lines 110, 112, 120, 122 and transistors 115 125 may be disposed on a layer of the substrate other than the first layer of the substrate.

Also shown in FIG. 1 is an axis of symmetry 101. Inductors 102 and 104 are step-symmetric about the axis of symmetry 101 that lies midway between those inductors. The first transistor 115, the second transistor 125, and interconnect lines 110, 120, 112 and 122 have a minor symmetry about the axis of symmetry 101.

FIG. 2 shows a prior art example layout 200 of a twin-spiral inductor 201. The twin-spiral inductor 201 may include a first spiral inductor 202 and a second spiral inductor 203 disposed on a first layer of a substrate. The twin-spiral inductor 201 also may include a central point 225 disposed on the twin-spiral inductor 201 and located midway between the first spiral inductor 202 and the second spiral inductor 203. The twin-spiral inductor 201 may be point-symmetric when every point of the twin-spiral inductor 201 has a corresponding point that is an identical, or near-identical distance from the central point 225 but in the opposite direction. Thus, each point of the first spiral inductor 202 has a corresponding point an identical, or near identical distance but in an opposite direction in the second spiral inductor 203.

The twin-spiral inductor 201 may include a first terminal 204 and a second terminal 208. A first interconnect line 210 may be coupled to the first terminal 204, and a second interconnect line 212 may be coupled to the second terminal 208. The dashed lines indicate that the interconnect lines 210 and 212 may be disposed on a layer other than the first layer of the substrate. The first interconnect line 210 and the second interconnect line 212 extend outward from the inductor 201 (e.g., outward from the central point 225), where they may be connected to other electrical components, such as resistors, capacitors and transistors, and other circuits or devices not shown for simplicity.

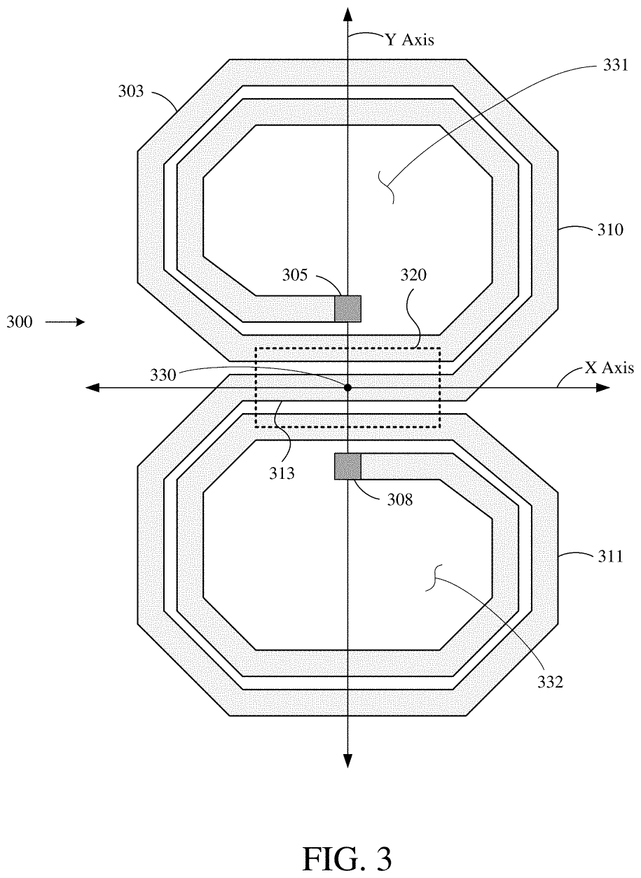

FIG. 3 is a top view of an example layout of a differential circuit 300 in accordance with some embodiments. The differential circuit 300 may include an implementation of a twin-spiral inductor 303. The twin-spiral inductor 303 may be formed in or upon a first layer of a substrate. In some aspects, the substrate may be at least part of an integrated circuit or at least part of a printed circuit board. The twin-spiral inductor 303 may include a first terminal 305 and a second terminal 308.

The twin-spiral inductor 303 may include a first spiral inductor 310 that spirals outward in a first direction from the first terminal 305, and may include a second spiral inductor 311 that spirals outward in a second direction (opposite to the first direction) from the second terminal 308. As shown, the first spiral inductor 310 spirals clockwise from the first terminal 305, and the second spiral inductor 311 spirals counter-clockwise from the second terminal 308. In another implementation, the first spiral inductor 310 may spiral counter-clockwise from the first terminal 305, and the second spiral inductor 311 may spiral clockwise from the second terminal 308. The twin-spiral inductor 303 may also include a crossover conductor 313 disposed midway between the first terminal 305 and the second terminal 308 that couples the first spiral inductor 310 to the second spiral inductor 311. In some implementations, the first spiral inductor 310 and the second spiral inductor 311 may each have a generally octagonal shape. In other implementations, the first spiral inductor 310 and the second spiral inductor 311 may each have other suitable shapes.

The twin-spiral inductor 303 may be point-symmetric about a central point 330, which may be an origin of a reference coordinate system including X and Y axes. As shown in FIG. 3, the X axis is colinear with the crossover conductor 313, and the Y axis is perpendicular to the crossover conductor 313, however other orientations are possible. The X axis may bisect the crossover conductor 313 as shown. The first terminal 305 and the second terminal 308 may be located at ends of inner loops of the first spiral inductor 310 and the second spiral inductor 311, and also may be located on the Y axis. Further, the first terminal 305 and second terminal 308 may be located proximal to the crossover conductor 313 (and, by extension, the origin of the reference coordinate system) and not, for example, distal from the crossover conductor 313 (e.g., separated by an open region of the first spiral inductor 310 and the second spiral inductor 311, respectively). As shown, an open region 331 of the first spiral inductor 310 and an open region 332 of the second spiral inductor 311 may be devoid of any loops of the associated spiral inductor.

The differential circuit 300 may include a crossover area 320 (shown as a dotted line) that includes at least a portion of the crossover conductor 313 and one or more adjacent loops from the first spiral inductor 310 and the second spiral inductor 311. The crossover area 320 may be projected normal to the plane containing the twin-spiral inductor 303. In some implementations, one or more electronic devices and/or components may be disposed within the crossover area 320 projected onto other layers or sides of the substrate. For example, electronic devices and/or components such as transistors, resistors and capacitors may be disposed on a layer within the projected crossover area 320 and “beneath” the crossover conductor 313 and associated adjacent loops of the first spiral inductor 310 and the second spiral inductor 311. In some implementations, a device may be considered to be beneath another device when a line that is normal to the plane of the substrate intersects both devices. The electronic devices and/or components beneath the crossover area 320 may be coupled to the inductor 303 to form a voltage-controlled oscillator (VCO), a low-noise amplifier (LNA), or any other feasible electronic circuit.

The first terminal 305 and the second terminal 308 may be coupled to conductive vias and/or traces, not shown for simplicity, to couple the twin-spiral inductor 303 to the electronic devices and/or components beneath the crossover area 320. Locating the first terminal 305 and the second terminal 308 proximal to the crossover area 320 may help minimize interference between the twin-spiral inductor 303 and any electronic devices and/or components disposed beneath the crossover area 320.

In some implementations, a degradation or change of inductive characteristics of the twin-spiral inductor 303 may be avoided by careful placement of the electronic devices and/or components, for example, in a manner that avoids current loops beneath the inductor and thereby generates little or no Eddy currents (which may adversely affect the characteristics of the twin-spiral inductor 303. Advantageously, the point of symmetry and the crossover conductor 313 may operate at virtual ground potential. Therefore, any parasitic capacitance between the inductor and the other devices that are disposed beneath the crossover conductor 313 does not load (e.g., affect the characteristics of) the twin-spiral inductor 303.

In some implementations, the electronic devices and/or components that are beneath the crossover area 320 may be arranged in minor symmetry about the X axis. Alternatively, the electronic devices and/or components that are beneath the crossover area 320 may be arranged to be in minor symmetry about the Y axis. In either case, the symmetry between the two halves of an associated differential circuit that includes the twin-spiral inductor 303 may be maintained.

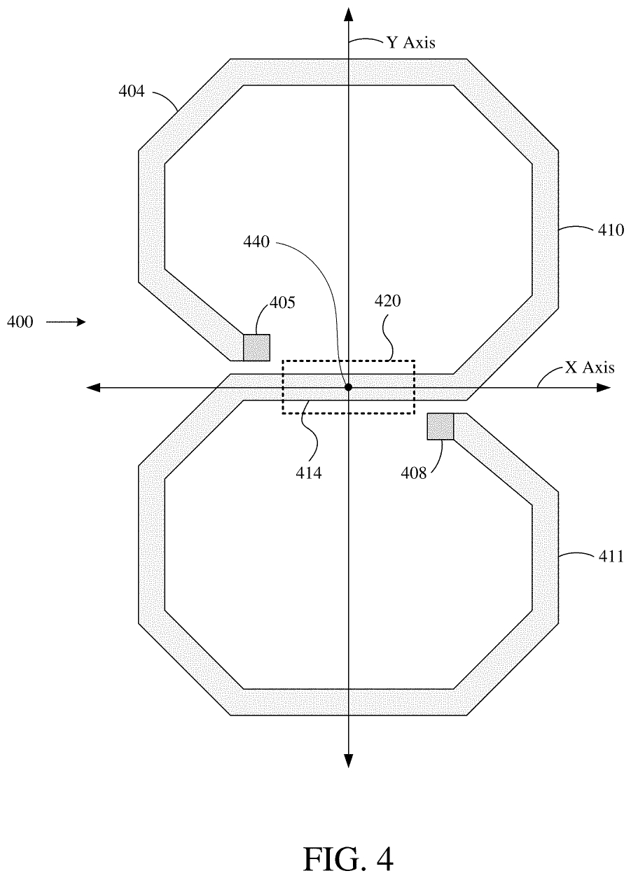

FIG. 4 is a top view of another example layout of a differential circuit 400. The differential circuit 400 may include another embodiment of a point-symmetric twin-spiral inductor 404. The twin-spiral inductor 404 may be formed in or upon a first layer of a substrate that may be at least part of an integrated circuit or a printed circuit board. The twin-spiral inductor 404 may include a first spiral inductor 410, a second spiral inductor 411, and a crossover conductor 414. In some implementations, the first spiral inductor 410 and the second spiral inductor 411 may have a generally octagonal shape. In other implementations, the first spiral inductor 410 and the second spiral inductor 411 may each have other suitable shapes

The twin-spiral inductor 404 may be point-symmetric about a central point 440, which may be an origin of a reference coordinate system comprising X and Y axes. As shown in FIG. 4, the X axis is colinear with the crossover conductor 414, and the Y axis is perpendicular to the crossover conductor 414, however other orientations are possible. The X axis may bisect the crossover conductor 414, for example, as shown in FIG. 4.

In this example, the first spiral inductor 410 and the second spiral inductor 411 each include a single conductive loop, coupled together by a crossover conductor 414 beneath which other electronic devices and/or components may be arranged or positioned. The twin-spiral inductor 404 may include a first terminal 405 and a second terminal 408. The first terminal 405 and the second terminal 408 may be located at ends of inner loops of the first spiral inductor 410 and the second spiral inductor 411, respectively. Similar to the twin-spiral inductor 303 of FIG. 3, the first terminal 405 and second terminal 408 may be located proximal to the crossover conductor 414 (and the origin of the reference coordinate system) and not, for example, distal from the crossover conductor 414 by an open region of the first spiral inductor 410 and the second spiral inductor 411, respectively.

The differential circuit 400 may include a crossover area 420 (denoted with a dotted line) which in turn includes at least portion of the crossover conductor 414. Some electronic devices and/or components such as transistors, resistors and capacitors may be located beneath the crossover area 420 and placed on other layers of the substrate. Placing electronic devices and/or components beneath the crossover area 420 may have adverse effects on the characteristics of the twin-spiral inductor 404. Minor symmetry of the electronic devices and/or components disposed beneath the crossover area 420 may be accomplished, for example, by having conductive lines such as interconnect lines (not shown for simplicity) for terminals 405 and 408 extend in a direction parallel to the X axis or the Y axis by an amount that is symmetric about the other axis.

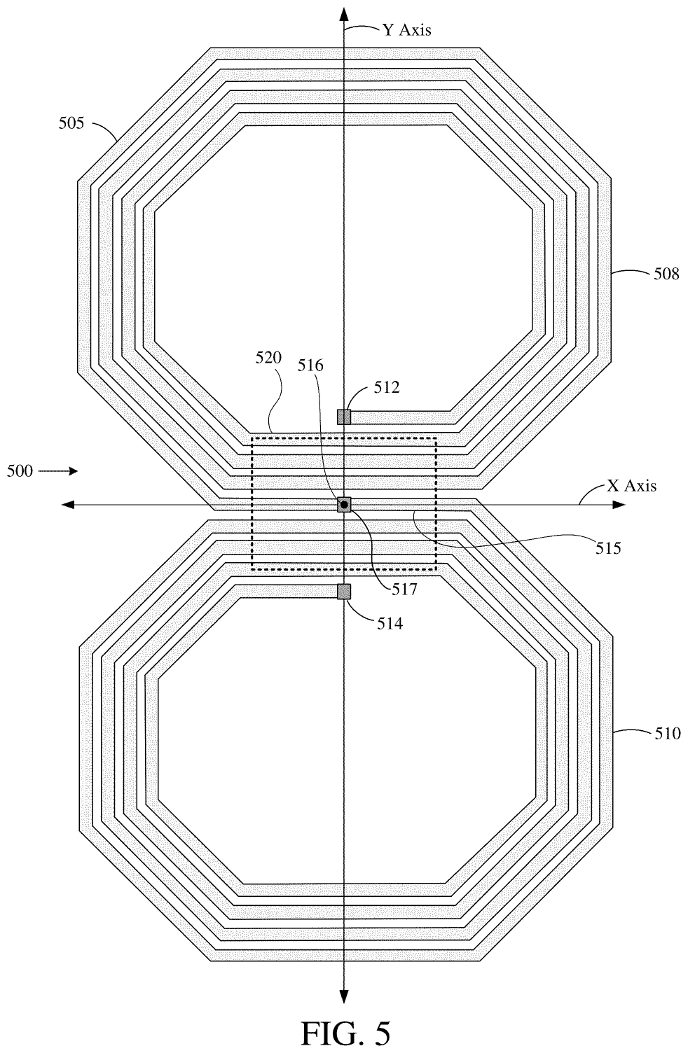

FIG. 5 is a top view of still another example layout of a differential circuit 500. The differential circuit 500 may include another embodiment of a point-symmetric twin-spiral inductor 505. The twin-spiral inductor 505 may be formed in or upon a first layer of a substrate that may be at least part of an integrated circuit or a printed circuit board. The twin-spiral inductor 505 may include a first spiral inductor 508, a second spiral inductor 510, and a crossover conductor 515. In some implementations, the first spiral inductor 508 and the second spiral inductor 510 may have a generally octagonal shape. In other implementations, the first spiral inductor 508 and the second spiral inductor 510 have other suitable shapes.

The twin-spiral inductor 505 may be point-symmetric about a central point 516, which may be an origin of a reference coordinate system comprising X and Y axes. As shown in FIG. 4, the X axis is colinear with the crossover conductor 515, and the Y axis is perpendicular to the crossover conductor 515, however other orientations are possible. The X axis may bisect the crossover conductor 515, for example, as shown in FIG. 5.

In this example, the first spiral inductor 508 and second spiral inductor 510 may have more loops compared to the twin-spiral inductor 303 of FIG. 3, or the twin-spiral inductor 404 of FIG. 4. The additional loops may increase an associated inductance value of the twin-spiral inductor 505, compared to other twin-spiral inductors having fewer loops.

The twin-spiral inductor 505 may include a first terminal 512 and a second terminal 514. The first terminal 512 and the second terminal 514 may be located at ends of inner loops of the first spiral inductor 508 and the second spiral inductor 510. Similar to the twin-spiral inductor 303 of FIG. 3, the first terminal 512 and second terminal 514 may be located proximal to the crossover conductor 515 (and the origin of the reference coordinate system) and not, for example, distal from the crossover conductor 515 by an open region of the first spiral inductor 508 and the second spiral inductor 510, respectively.

The differential circuit 500 may include a crossover area 520 (shown as a dotted line) that includes at least a portion of the crossover conductor 515 and one or more adjacent loops from the first spiral inductor 508 and the second spiral inductor 510. The crossover area 520 may be projected normal to the plane containing the twin-spiral inductor 505. In some implementations, one or more electronic devices and/or components may be disposed within the crossover area 520 projected onto other layers of the substrate.

The crossover area 520 may be larger than the crossover area 320 of FIG. 3 and the crossover area 420 of FIG. 4 due, at least in part, to the additional loops of the first spiral inductor 508 and the second spiral inductor 510 compare at least to the twin-spiral inductor 303 and the twin-spiral inductor 404. The larger crossover area 520 may allow additional or larger electrical devices and/or components to be placed beneath the crossover area 520 and coupled to the twin-spiral inductor 505.

In some implementations, the twin-spiral inductor 505 may include a third terminal 517 approximately midway between the first terminal 512 and the second terminal 514. The third terminal 517 may be located at the origin of the X and Y axes, and therefore located at a point of symmetry of the twin-spiral inductor 505. In some implementations, the third terminal 517 may be associated with the first spiral inductor 508 and/or the second spiral inductor 510. Further, for some implementations, the third terminal 517 may function as a virtual ground within the differential circuit 500.

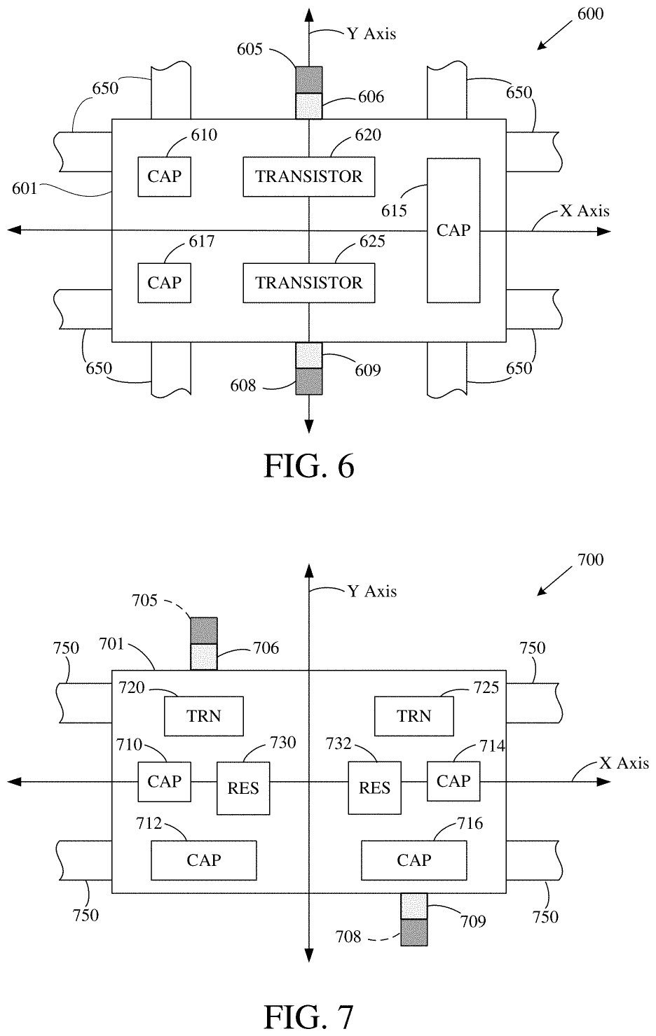

FIG. 6 is a top view of an example layout 600 of one or more electronic devices that may located beneath a crossover area 601. The layout 600 may include a first transistor 620, a second transistor 625, a first capacitor 610, a second capacitor 615 and a third capacitor 617. In other implementations, the layout 600 may include more, fewer, or different components. For example, the layout 600 also may include one or more resistors, diodes or any other feasible circuits or devices. The crossover area 601 may be an implementation of the crossover area 320 of FIG. 3, the crossover area 420 of FIG. 4, the crossover area 520 of FIG. 5, or any other feasible crossover area. The layout 600 also shows the X and Y axes of a reference coordinate system.

One or more of the devices within the crossover area 601 may be coupled to an embodiment of a twin-spiral inductor (e.g., the twin-spiral inductor 303 of FIG. 3, the twin-spiral inductor 404 of FIG. 4, the twin-spiral inductor 505 of FIG. 5, or any other feasible twin-spiral inductor) not shown for simplicity. As described above with respect to FIGS. 3-5, the twin-spiral inductor may include a first terminal 605 and a second terminal 608. The first terminal 605 and the second terminal 608 may be near the origin of the reference coordinate system. One or more devices within the crossover area 601 may be coupled to the twin-spiral inductor by a first conductor 606 coupled to the first terminal 605 and a second conductor 609 coupled to the second terminal 608. In some implementations, the first terminal 605 may be coupled to the first terminal 305 of FIG. 3, the first terminal 405 of FIG. 4 or the first terminal 512 of FIG. 5. Similarly, the second terminal 608 may be coupled to the second terminal 308 of FIG. 3, the second terminal 408 of FIG. 4 or the second terminal 514 of FIG. 5.

The first transistor 620, the second transistor 625, the first capacitor 610, the second capacitor 615, and the third capacitor 617 may be arranged in a minor symmetry about the X axis. Electrical conductors 650 may provide input, output, and power supply lines for the first transistor 620, the second transistor 625, the first capacitor 610, the second capacitor 615, and/or the third capacitor 617. Although only eight electrical conductors 650 are shown, in other implementations, the layout 600 may include any feasible number of electrical conductors.

FIG. 7 is a top view of another example layout 700 of one or more electronic devices that may located beneath a crossover area 701. The layout 700 may include a first transistor 720, a second transistor 725, a first capacitor 710, a second capacitor 712, a third capacitor 714, a fourth capacitor 716, a first resistor 730, and a second resistor 732. In other implementations, the layout 700 may include more, fewer, or different components. For example, the layout 700 also may include one or more diodes or any other feasible devices. The crossover area 701 may be an implementation of the crossover area 320 of FIG. 3, the crossover area 420 of FIG. 4, the crossover 520 of FIG. 5 or any other feasible crossover area. The layout 700 also shows the X and Y axes of a reference coordinate system.

One or more of the devices within the crossover area 701 may be coupled to an embodiment of a twin-spiral inductor (e.g., the twin-spiral inductor 404 of FIG. 4 or any other feasible twin-spiral inductor) not shown for simplicity. As described above with respect to FIGS. 3-5, the twin-spiral inductor may include a first terminal 705 and a second terminal 708. One or more devices within the crossover area 701 may be coupled to the twin-spiral inductor by a first conductor 706 coupled to the first terminal 705 and a second conductor 709 coupled to the second terminal 708. In some implementations, the first terminal 705 may be coupled to the first terminal 305 of FIG. 3, the first terminal 405 of FIG. 4 or the first terminal 512 of FIG. 5. Similarly, the second terminal 708 may be coupled to the second terminal 308 of FIG. 3, the second terminal 408 of FIG. 4 or the second terminal 514 of FIG. 5.

In some implementations, the first transistor 720, the second transistor 725, the first capacitor 710, the second capacitor 712, the third capacitor 714, the fourth capacitor 716, the first resistor 730, and the second resistor 732 may be arranged in a minor symmetry about the Y axis. Electrical conductors 750 may provide input, output, and power supply lines for the first transistor 720, the second transistor 725, the first capacitor 710, the second capacitor 712, the third capacitor 714, the fourth capacitor 716, the first resistor 730, and/or the second resistor 732. Although only four electrical conductors 750 are shown, in other implementations, the layout 700 may include any feasible number of electrical conductors.

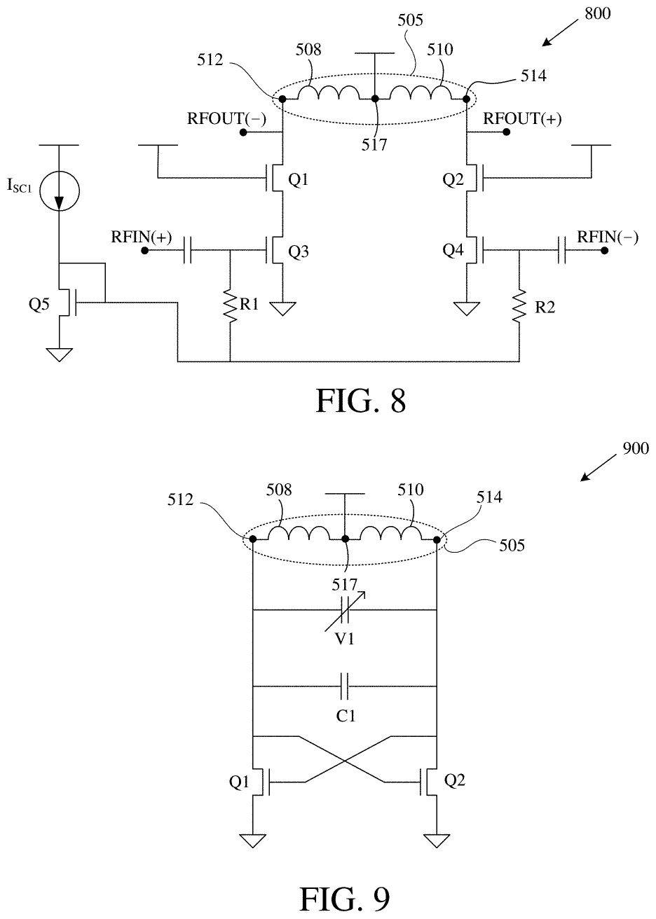

FIG. 8 is an example schematic of an RF amplifier circuit 800 that may include the twin-spiral inductor 505 of FIG. 5. In other implementations, other twin-spiral inductors such as the twin-spiral inductor 303 of FIG. 3 and the twin-spiral inductor 404 of FIG. 4 may be used. The RF amplifier circuit also may include a transistors Q1-Q5, resistors R1-R2, capacitors C1-C2, and a current source Isci. As shown, the twin-spiral inductor 505 includes a first spiral inductor 508 and a second spiral inductor 510. The first terminal 512 of the twin-spiral inductor 505 may be coupled to a drain terminal of the transistor Q1 and the second terminal 514 may be coupled to a drain terminal the transistor Q2. The third terminal 517 may be coupled to a reference voltage. In some implementations, the transistors Q1-Q5, the resistors R1-R2, the capacitors C1-C2 may be arranged in a minor symmetry about the X or Y axis beneath the crossover area 520 (not shown for simplicity) of the twin-spiral inductor 505.

FIG. 9 is an example schematic of a VCO circuit 900 that may include the twin-spiral inductor 505 of FIG. 5 (shown within a dotted line). In other implementations, other twin-spiral inductors such as the twin-spiral inductor 303 of FIG. 3 or the twin-spiral inductor 404 of FIG. 4 may be used. The VCO circuit 900 also may include a varactor V1, a capacitor C1, and transistors Q1 and Q2. As shown, the twin-spiral inductor 505 includes a first spiral inductor 508 and a second spiral inductor 510. The third terminal 517 may be coupled to a reference voltage. The first terminal 512 of the twin-spiral inductor 505 may be coupled to a first terminal of the varactor V1 and the second terminal 514 may be coupled to a second terminal the varactor V1. The first terminal 512 of the twin-spiral inductor 505 may be coupled to a drain terminal of the transistor Q1 and the second terminal 514 may be coupled to a drain terminal the transistor Q2. The varactor V1, the capacitor C1, and the transistors Q1 and Q2 may be arranged in a symmetry about the X or Y axis beneath the crossover area 520 (not shown for simplicity) of the twin-spiral inductor 505.

In the foregoing specification, the example embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. An apparatus including a twin-spiral inductor disposed on a first side of a plane, the twin-spiral inductor comprising:
a first spiral inductor configured to loop in a first direction;
a second spiral inductor configured to loop in a second direction, opposite to the first direction;
a crossover conductor configured to couple the first spiral inductor to the second spiral inductor;
a first terminal disposed on an end of an inner loop of the first spiral inductor proximal to the crossover conductor; and
a second terminal disposed on an end of an inner loop of the second spiral inductor proximal to the crossover conductor, wherein each portion of the first spiral inductor has a corresponding portion in the second spiral inductor that is an identical distance, in an opposite direction, from a central point of the twin-spiral inductor.

2. The apparatus of claim 1, further comprising:
a circuit comprising one or more components disposed on a second side of the plane beneath the crossover conductor and coupled to the first terminal and the second terminal

3. The apparatus of claim 1, wherein the first terminal and the second terminal are disposed on a line crossing through the central point and perpendicular to the crossover conductor.

4. The apparatus of claim 1, wherein the first spiral inductor and the second spiral inductor are configured to have an octagonal shape.

5. The apparatus of claim 1, wherein the first spiral inductor and the second spiral inductor further comprise a plurality of loops, and wherein at least a portion of the plurality of loops are disposed parallel to the crossover conductor.

6. The apparatus of claim 5, wherein the twin-spiral inductor further comprises a crossover area including the crossover conductor and the portion of the plurality of loops disposed parallel to the crossover conductor.

7. The apparatus of claim 6, further comprising one or more circuit elements disposed within an area beneath the crossover area on a second side of the plane.

8. The apparatus of claim 7, wherein the one or more circuit elements are disposed in a minor symmetry about a line bisecting the crossover conductor.

9. The apparatus of claim 7, wherein the one or more circuit elements are disposed in a minor symmetry about a line crossing through the central point and perpendicular to the crossover conductor.

10. The apparatus of claim 1, wherein the twin-spiral inductor comprises a third terminal disposed on the crossover conductor.

11. The apparatus of claim 10, wherein the third terminal is configured to operate as a virtual ground.

12. A circuit including a twin-spiral inductor disposed on a first side of a substrate, the twin-spiral inductor comprising:
a first spiral inductor configured to loop in a first direction;
a second spiral inductor configured to loop in a second direction, opposite to the first direction;
a crossover conductor configured to couple the first spiral inductor to the second spiral inductor;
a first terminal disposed on an end of an inner loop of the first spiral inductor proximal to the crossover conductor; and
a second terminal disposed on an end of an inner loop of the second spiral inductor proximal to the crossover conductor, wherein each portion of the first spiral inductor has a corresponding portion in the second spiral inductor that is an identical distance, in an opposite direction, from a central point of the twin-spiral inductor;
a first transistor including a terminal coupled to the first terminal of the first spiral inductor; and
a second transistor including a terminal coupled to the second terminal of the second spiral inductor,
wherein the first transistor and the second transistor are disposed on a second side of the substrate within a crossover area of the twin-spiral inductor.

13. The circuit of claim 12, wherein the crossover area is configured to include the crossover conductor and one or more loops of the first spiral inductor and the second spiral inductor disposed parallel to the crossover conductor.

14. The circuit of claim 12, wherein the first transistor and the second transistor are disposed in a minor symmetry about a line bisecting the crossover conductor.

15. The circuit of claim 12, therein the first transistor and the second transistor are disposed in a minor symmetry about a line crossing through the central point and perpendicular to the crossover conductor.

16. The circuit of claim 12 wherein the substrate is one of an integrated circuit or a printed circuit board.
